(19) United States
(12) Patent Application Publication
(10) Pub. No.: US 2014/0079988 A1
(43) Pub. Date: Mar. 20, 2014

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventor: Su-Hee Han, Yongin-si (KR)

(73) Assignee: SAMSUNG SDI CO., LTD., Yongin-si (KR)

(21) Appl. No.: 14/017,840

(22) Filed: Sep. 4, 2013

Related U.S. Application Data
(60) Provisional application No. 61/703,525, filed on Sep. 20, 2012.

(51) Int. Cl. H01M 10/0567; H01M 10/052

(52) U.S. Cl. CPC H01M 10/0567; H01M 10/052
USPC 429/189

(57) ABSTRACT

An electrolyte for a rechargeable lithium battery includes: an alkyl acrylate additive having a C4 to C15 alkyl group; fluoroethylene carbonate; a polymerizable component and a polymerization initiator; a lithium salt; and an organic solvent.

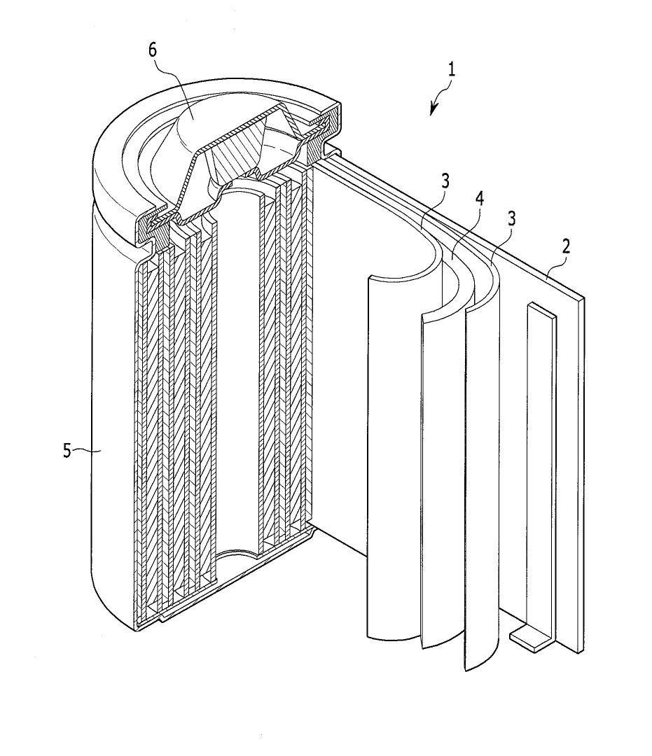

### CROSS-REFERENCE TO RELATED APPLICATION

This application claims priority to and the benefit of U.S. Provisional Application No. 61/703,525, filed on Sep. 20, 2012 in the U.S. Patent and Trademark Office, the entire content of which is incorporated herein by reference.

### BACKGROUND

(a) Field

This disclosure relates to an electrolyte for a rechargeable lithium battery and a rechargeable lithium battery including the same.

(b) Description of the Related Art

In recent years, due to reduction in size and weight of portable electronic devices, and popularization of these portable electronic devices, researches on rechargeable lithium batteries having high energy density as a power source for these portable electronic devices have been actively made. Rechargeable lithium batteries include a negative electrode, a positive electrode, and an electrolyte, and generate electrical energy by oxidation and reduction reactions when lithium ions are intercalated/deintercalated in the positive electrode and negative electrode.

Such rechargeable lithium batteries use a lithium metal, a carbon-based material, Si, or the like for a negative active material. For a positive active material of rechargeable lithium batteries, metal chalcogenide compounds capable of intercalating and deintercalating lithium ions, for example, composite metal oxides such as LiCoO₂, LiMn₂O₄, LiNiO₂, LiNi₁₋ₓCoₓO₂ (0<X<1), LiMnO₂, or the like, have been used.

### SUMMARY

Aspects of embodiments of the present invention are directed toward an electrolyte for a rechargeable lithium battery exhibiting good formation capacity and cycle-life characteristics.

Aspects of embodiments of the present invention are directed toward a rechargeable lithium battery including the electrolyte.

According to an embodiment, an electrolyte (electrolyte mixture) includes an alkyl acrylate additive having a C4 to C15 alkyl group; fluoroethylene carbonate; a polymerizable component; a polymerization initiator; a lithium salt; and an organic solvent.

The alkyl acrylate may be a halogenated alkyl acrylate. The halogen may be F, Cl, Br, I, or a combination thereof. The halogenated alkyl acrylate may be alkyl acrylate in which at least 1 to 31 hydrogen atoms of the alkyl group may be substituted with halogens. The alkyl acrylate additive may include a material selected from n-butyl acrylate, hexyl acrylate, isodecyl acrylate, heptafluoro butyl acrylate, and combinations thereof.

The amount of the additive may be about 1.25 wt % to about 2 wt % based on 100 wt % of the total weight of the electrolyte. The polymerizable component may be present in the electrolyte in an amount of about 1 wt % to about 20 wt % based on the total weight of the alkyl acrylate additive, the fluoroethylene carbonate, the polymerizable component, the lithium salt, and the organic solvent. A weight ratio of the alkyl acrylate additive to the polymerizable component may be in a range of 1:2 to 1:10. The electrolyte may have a viscosity of 4 centipoises (cPs) to 30 centipoises (cPs). The polymerizable component may include a material selected from a multifunctional acrylate, poly(ethylene glycol)dimethacrylate, poly(ethylene glycol)diacrylate, poly(ethylene glycol)divinyl ether, ethylene glycol dimethacrylate, ethylene glycol diacrylate, ethylene glycol divinyl ether, hexanediol diacrylate, tripropylene glycol diacrylate, tetraethylene glycol monoacrylate, caprolactone acrylate, a polyester polyol, and combinations thereof.

The polymerizable component may include a material represented by Chemical Formula 1.

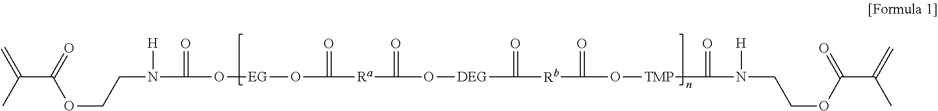

wherein, R^{a} and R^{b} are the same or different, and are substituted or unsubstituted C1 to C6 alkylene;
EG is a moiety of ethylene glycol;
DEG is a moiety of diethylene glycol; and
TMP is a moiety of trimethylolpropane.

The fluoroethylene carbonate may be included in a range of about 1 wt % to about 20 wt % based on the total weight of the electrolyte. The total weight of the fluoroethylene carbonate and the organic solvent may be about 90 wt % to about 95 wt % based on the total weight of the electrolyte.

A polymer electrolyte may include a reaction product of the electrolyte disclosed above. The polymer electrolyte may be a gel electrolyte.

According to another embodiment, a rechargeable lithium battery includes an electrolyte; a positive electrode including a positive active material; and a negative electrode including a negative active material. The electrolyte includes the reaction product of an electrolyte mixture that includes: an alkyl acrylate additive comprising a C4 to C15 alkyl group; fluoroethylene carbonate; a polymerizable component; a polymerization initiator; a lithium salt; and an organic solvent. The electrolyte for a rechargeable lithium battery may improve the formation capacity and the cycle-life characteristics.

### BRIEF DESCRIPTION OF THE DRAWING

The drawing is a schematic view illustrating a structure of a rechargeable lithium battery according to one embodiment.

### DETAILED DESCRIPTION

Example embodiments will hereinafter be described in more detail. However, these embodiments are examples, and this disclosure is not limited thereto. Expressions such as “at least one of,” when preceding a list of elements, modify the entire list of elements and do not modify the individual elements of the list. Further, the use of “may” when describing embodiments of the present invention refers to “one or more embodiments of the present invention.”

An electrolyte (or electrolyte mixture) for a rechargeable lithium battery according to one embodiment includes: an alkyl acrylate additive having a C4 to C15 alkyl group; fluoroethylene carbonate; a polymerizable component; a polymerization initiator; a lithium salt; and an organic solvent.

If there are less than 4 carbons in the alkyl group, the electrolyte may facilitate the deterioration of the cycle-life characteristics. If there are more than 15 carbons in the alkyl group, the electrolyte may cause a decrease in the capacity of the battery.

The alkyl acrylate may be n-butyl acrylate, isodecyl acrylate, hexyl acrylate, or a combination thereof. The alkyl acrylate may be a halogenated alkyl acrylate. The halogen may be F, Cl, Br, I, or a combination thereof.

The halogenated alkyl acrylate may be an alkyl acrylate of which at least 1 to 31 hydrogen atoms may be each substituted with a halogen. In one embodiment, the halogenated alkyl acrylate is an alkyl acrylate of which at least 1 to 4 hydrogen atoms may be each substituted with a halogen. The halogen alkyl acrylate may be heptafluoro butyl acrylate. The halogenated alkyl acrylate provides improved safety and rate capability to the battery.

The amount of the additive may be about 1.25 wt % to about 2 wt % based on 100 wt % of the total weight of the electrolyte. In one embodiment, when the amount of the additive is within the above range, it effectively suppresses uncharged portion generation, and it gives high formation capacity. Furthermore, in one embodiment, when the amount of the additive is within the above range, it gives more improved cycle-life characteristics and capacity to the battery.

The amount of fluoroethylene carbonate may be about 1 wt % to about 20 wt % based on 100 wt % of the total weight of the electrolyte. Such an amount of fluoroethylene carbonate allows improvement in the cycle-life characteristics and effectively suppresses swelling problems.

The electrolyte may be a gel electrolyte. Particularly, such a gel electrolyte may be a chemical polymer electrolyte obtained from polymerization reaction conducted within a battery. The gel electrolyte may be prepared by adding a polymerizable component and a polymerization initiator to a mixture of an alkyl acrylate additive, fluoroethylene carbonate, a lithium salt, and an organic solvent to prepare an electrolyte mixture, fabricating a battery using the solution (the electrolyte mixture), and conducting a polymerization and cross-linking reaction within the battery. If the alkyl acrylate additive is used in a liquid electrolyte (rather than a gel electrolyte), the desired cycle-life characteristics cannot be obtained.

The polymerizable component may include a compound having at least one carbon-carbon double bond, and may include polymers that can be further polymerized or cross-linked. Example polymerizable components thereof may include multifunctional acrylate (a polyester(meth)acrylate polymer in which an —OH group of a polyester polyol is partially substituted with (meth)acrylic acid ester); poly(ethylene glycol)dimethacrylate, poly(ethylene glycol)diacrylate; poly(ethylene glycol)divinyl ether; ethylene glycol dimethacrylate; ethylene glycol diacrylate; ethylene glycol divinyl ether hexanediol diacrylate; tripropylene glycol diacrylate; tetraethylene glycol monoacrylate, caprolactone acrylate; polyester polyol; or a combination thereof. The polyester polyol may be obtained by esterification-reacting multifunctional carboxylic acid with an alcohol. The multifunctional carboxylic acid may be adipic acid, and the alcohol may be ethylene glycol, propylene glycol, alkane diol, ethoxylated alkanediol, propoxylated alkanediol, trimethylol propane, ethoxylated trimethylol propane, propoxylated trimethylol propane, ditrimethylol propane, ethoxylated ditrimethylol propane, propoxylated ditrimethylol propane, pentaerythritol, ethoxylated pentaerythritol, propoxylated dipentaerythritol, bisphenol A, ethoxylated bisphenol A, propoxylated bisphenol A, or a combination thereof.

The polymerizable component may include a material represented by Chemical Formula 1.

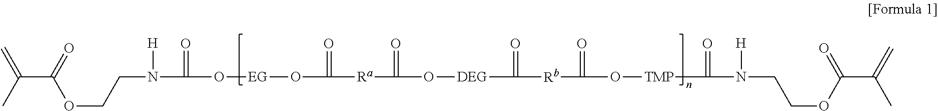

wherein, R^{a} and R^{b} are the same or different, and are substituted or unsubstituted C1 to C6 alkylene;
EG is a moiety of ethylene glycol;
DEG is a moiety of diethylene glycol; and
TMP is a moiety of trimethylolpropane.

The substituted alkylene refers to an alkylene of which at least one hydrogen is substituted with C1 to C3 alkyl.
The polymerizable component represented by Formula 1 may have a weight average molecular weight of about 10,000 to 100,000.

The amount of the polymerizable component may be suitably controlled, and for example, the amount of the polymerizable component may be about 1 wt % to about 20 wt % based on the total weight of the electrolyte. If the amount of the polymerizable component is more than 20 wt %, this severely increases the viscosity of the resulting electrolyte, thereby inhibiting an immersion of the electrolyte into the electrode, so that the uncharged areas become enlarged, thereby deteriorating the initial capacity characteristics and the cycle-life characteristics. In contrast, an amount of less than 1 wt % of the polymerization component is not sufficient to form a gel, and thus results in a decrease in the adhesion between the electrodes, thereby increasing resistance and deteriorating the cycle-life characteristics, and bending the battery during the charge and discharge. A weight ratio of the alkyl acrylate additive to the polymerizable component may be in a range of 1:2 to 1:10.

For the polymerization initiator, any suitable material being capable of easily initiating polymerization of the polymerizable components and not deteriorating battery performance may be used. Example initiators may be either organic peroxide or an azo-based compound, or a mixture thereof. The organic peroxide may include peroxydicarbonates such as di(4-t-butylcyclohexyl)peroxydicarbonate, di-2-ethylhexyl peroxydicarbonate, di-isopropyl peroxydicarbonate, di-3-methoxybutyl peroxydicarbonate, t-butyl peroxy-isopropyl carbonate, t-butylperoxy-2-ethylhexyl carbonate, 1,6-bis(t-butyl peroxycarbonyloxy)hexane, diethyleneglycol-bis(t-butyl peroxycarbonate), and the like; diacyl peroxides such as diacetyl peroxide, dibenzoyl peroxide, dilauroyl peroxide, bis-3,5,5-trimethyl hexanoyl peroxide, and the like; and peroxyesters such as perhexyl pivalate, t-butyl peroxy pivalate, t-amyl peroxy pivalate, t-butyl peroxy-2-ethyl-hexanoate, t-hexyl peroxy pivalate, t-butyl peroxy neoheptanoate, t-butyl peroxy neoheptanoate, t-hexyl peroxy pivalate, 1,1,3,3-tetramethylbutyl peroxy neodecarbonate, 1,1,3,3-tetramethylbutyl 2-ethylhexanoate, t-amylperoxy 2-ethylhexanoate, t-butyl peroxy isobutyrate, t-amylperoxy 3,5,5-trimethyl hexanoyl, t-butyl peroxy 3,5,5-trimethylhexanoate, t-butyl peroxy acetate, t-butyl peroxy benzoate, di-butylperoxy trimethyl adipate, and the like. The azo-based compounds include 2,2′-azo-bis(isobutyronitrile), 2,2′-azo-bis(2,4-dimethylvaleronitrile), and 1,1′-azo-bis(cyanocyclo-hexane).

The polymerization initiator is added to the polymerization reaction composition (the electrolyte mixture) in an amount that may initiate the polymerization reaction of the polymerizable components. In one embodiment, the amount of the polymerization initiator is from about 0.01 wt % to about 0.4 wt % based on the total weight of the electrolyte.

When the included amount of the polymerization initiator is within the stated range, the polymerization initiator is consumed (substantially or fully consumed) during the polymerization process. Thus, the polymerization initiator may not remain in the prepared polymer electrolyte (the gel electrolyte). This is important because when the polymerization initiator is a peroxide-based compound, CO₂ gas may be generated. Also, when the polymerization initiator is an azo-based compound, N₂ gas may be generated. The absence of the polymerization initiator in the polymerized electrolyte (the gel electrolyte) prevents any sub-reactions such as the generation of gas due to the two reactions stated above. Also, adding an appropriate amount of the polymerization initiator to the polymerization reaction mixture ensures an appropriate degree of polymerization.

In an embodiment, the rechargeable lithium battery using the polymer electrolyte composition is prepared by fabricating an electrode assembly using a suitable process to include a positive electrode, a separator, and a negative electrode; inserting the electrode assembly into a battery case; injecting a polymerizable electrolyte mixture into the battery case; and curing the polymerizable electrolyte mixture in the battery case. Since the polymerization reaction between the polymerizable components is initiated by the polymerization initiator included in the polymer electrolyte mixture during the curing (polymerization) process to thereby form a polymer, the final battery includes an electrolyte existing in the form of (including) a polymer. The battery case may be a metal can or a metal-laminated pouch.

The organic solvent serves as a medium for transmitting ions taking part in the electrochemical reaction of the battery. The total weight of the fluoroethylene carbonate and the organic solvent may be about 90 wt % to about 95 wt % based on the total weight of the electrolyte. The organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent include methyl acetate, ethyl acetate, n-propyl acetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone and the like. Examples of the alcohol-based solvent include ethyl alcohol, isopropyl alcohol, and the like, and examples of the aprotic solvent include nitriles such as R—CN (where R is a C2 to C20 linear, branched, or cyclic hydrocarbon, a double bond, an aromatic ring, or an ether bond), amides such as dimethylformamide, dioxolanes such as 1,3-dioxolane, sulfolanes, and the like.

The organic solvent may be used singularly or in a mixture. When the organic solvent is used in a mixture, the mixing ratio can be controlled in accordance with a desirable battery performance.

The carbonate-based solvent may include a mixture of a cyclic carbonate and a linear carbonate. The cyclic carbonate and the linear carbonate are mixed together in a volume ratio of about 1:1 to about 1:9. When the mixture is used as an electrolyte, the electrolyte performance may be enhanced. In addition, the non-aqueous organic electrolyte may further include mixtures of carbonate-based solvents and aromatic hydrocarbon-based solvents. The carbonate-based solvents and the aromatic hydrocarbon-based solvents may be mixed together in a volume ratio of about 1:1 to about 30:1. The aromatic hydrocarbon-based organic solvent may be represented by the following Chemical Formula 2.

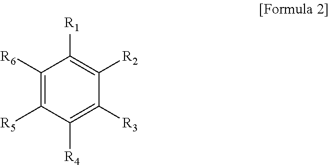

In Chemical Formula 2, R₁ to R₆ are, each independently, selected from hydrogen, a halogen, a C1 to C10 alkyl group, a C1 to C10 haloalkyl group, and a combination thereof. The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and combinations thereof. The electrolyte may further include a solvent of vinylene carbonate, an ethylene carbonate-based compound of the following Chemical Formula 3, or a combination thereof, as an additional additive for increasing the cycle-life characteristics.

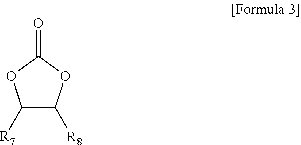

In Chemical Formula 3, R₇ and R₈ are the same or different, and are selected from hydrogen, a halogen, a cyano group (CN), a nitro group (NO₂), and a C1 to C5 fluoroalkyl group, provided that at least one of R₇ and R₈ is selected from a halogen, a cyano group (CN), a nitro group (NO₂), and a C1 to C5 fluoroalkyl group.

Examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. An amount of the additional additive for increasing the cycle-life characteristics may be suitably controlled.

The lithium salt supplies lithium ions in the battery for the basic operation of a rechargeable lithium battery, and improves lithium ion transportation between positive and negative electrodes. Examples of the lithium salt include at least one supporting salt selected from LiPF₆, LiBF₄, LiSbF₆, LiAsF₆, LiN(SO₂C₂F₆)₂, Li(CF₃SO₂)₂N, LiC₂F₅SO₃, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂ (lithium bisoxalato borate, LiBOB). The lithium salt may be used in a concentration ranging from about 0.1 M to about 2.0 M. In one embodiment, when the lithium salt is included at the above concentration range, electrolyte performance and lithium ion mobility are enhanced due to desired electrolyte conductivity and viscosity. In one embodiment, the electrolyte may has a viscosity of 4 centipoises (cPs) to 30 centipoises (cPs).

Another embodiment provides a rechargeable lithium battery including a negative electrode including a negative active material, a positive electrode including a positive active material, and the electrolyte. The electrolyte may be a gel electrolyte. Particularly, such a gel electrolyte may be a chemical polymer electrolyte obtained from polymerization reaction conducted within a battery. The gel electrolyte may be prepared by adding a polymerizable component and a polymerization initiator to a mixture of an alkyl acrylate additive, fluoroethylene carbonate, a lithium salt, and an organic solvent to prepare an electrolyte mixture, fabricating a battery using the solution (the electrolyte mixture), and conducting a polymerization and cross-linking reaction within the battery. If the alkyl acrylate additive is used in a liquid electrolyte (rather than a gel electrolyte), the desired cycle-life characteristics cannot be obtained.

The negative electrode includes a current collector and a negative active material layer formed on the current collector. The negative active material layer includes the negative active material.

The negative active material includes a material that reversibly intercalates/deintercalates lithium ions, such as a lithium metal, a lithium metal alloy, a material capable of doping/dedoping lithium, or a transition metal oxide. The material that can reversibly intercalate/deintercalate lithium ions includes a carbon material.

The carbon material may be any generally-used carbon-based negative active material in a lithium ion rechargeable battery. Examples of the carbon material include crystalline carbon, amorphous carbon, and mixtures thereof. The crystalline carbon may be non-shaped (i.e., not having a well-defined geometry), or sheet, flake, spherical, or fiber shaped natural graphite or artificial graphite. The amorphous carbon may be a soft carbon, a hard carbon, a mesophase pitch carbonization product, fired coke, or the like.

Examples of the lithium metal alloy include lithium and an element selected from sodium (Na), potassium (K), rubidium (Rb), caesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn). The material capable of doping/dedoping lithium may include Si, a Si—C composite, SiOₓ (0<x<2), a Si-Q alloy (wherein Q is an element selected from an alkali metal, an alkaline-earth metal, a Group 13 element, a Group 14 element, a Group 15 element, a Group 16 element, a transition element, a rare earth element, and a combination thereof, and is not Si), Sn, SnO₂, a Sn—R alloy (wherein R is an element selected from an alkali metal, an alkaline-earth metal, a Group 13 element, a Group 14 element, a Group 15 element, a Group 16 element, a transition element, a rare earth element, and a combination thereof, and is not Sn), and the like. At least one of these materials may be mixed with SiO₂.

The element Q and R may be selected from Mg, Ca, Sr, Ba, Ra, scandium (Sc), yttrium (Y), titanium (Ti), zirconium (Zr), hafnium (Hf), furtherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), Pb, ruthenium (Ru), osmium (Os), hassium (Hs), rhodium (Rh), iridium (Ir), palladium (Pd), platinum (Pt), copper (Cu), silver (Ag), gold (Au), Zn, cadmium (Cd), boron (B), Al, gallium (Ga), Sn, In, Ge, phosphorus (P), arsenic (As), Sb, bismuth (Bi), sulfur (S), selenium (Se), tellurium (Te), polonium (Po) or combination thereof.

The transition metal oxide includes vanadium oxide, lithium vanadium oxide, or the like.

In the negative active material layer, the negative active material may be included in an amount of about 95 wt % to about 99 wt % based on the total weight of the negative active material layer. The negative active material layer may include a binder, and optionally a conductive material. The negative active material layer may include about 1 to about 5 wt % of a binder based on the total weight of the negative active material layer.

When the negative active material layer includes a conductive material, the negative active material layer includes about 90 wt % to about 98 wt % of the negative active material, about 1 wt % to about 5 wt % of the binder, and about 1 wt % to about 5 wt % of the conductive material.

The binder improves binding properties of the negative active material particles with one another and with a current collector. The binder includes a non-water-soluble binder, a water-soluble binder, or a combination thereof.

Examples of the non-water-soluble binder include polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, and combinations thereof. Examples of the water-soluble binder include a styrene-butadiene rubber, an acrylated styrene-butadiene rubber, polyvinyl alcohol, sodium polyacrylate, a copolymer including propylene and a C2 to C8 olefin, a copolymer of (meth)acrylic acid and (meth)acrylic acid alkyl ester, and a combination thereof.

When the water-soluble binder is used as a negative electrode binder, a cellulose-based compound may be further used to provide (modify) the viscosity.

Examples of the cellulose-based compound include one or more of carboxylmethyl cellulose, hydroxypropylmethyl cellulose, methyl cellulose, and alkaline metal salts thereof. The alkaline metal may be sodium (Na), potassium (K), or lithium (Li). The cellulose-based compound may be included in an amount of 0.1 to 3 parts by weight based on 100 parts by weight of the negative active material.

As for the conductive material, any suitable electro-conductive material that does not cause a chemical change may be used. Non-limiting examples of the conductive material include a carbon-based material such as natural graphite, artificial graphite, carbon black, acetylene black, ketjen black, and carbon fiber; a metal-based material such as a metal powder or a metal fiber including copper, nickel, aluminum, and silver; a conductive polymer such as a polyphenylene derivative; and a mixture thereof.

The negative electrode includes a current collector, and the current collector includes a copper foil, a nickel foil, a stainless steel foil, a titanium foil, a nickel foam, a copper foam, a polymer substrate coated with a conductive metal, or combinations thereof. The negative and positive electrodes may be fabricated by a method including mixing the active material, a conductive material, and a binder in a solvent to provide an active material composition, and coating the composition on a current collector. The negative electrode manufacturing method is known, and thus is not described in more detail in the present specification. The solvent may be N-methylpyrrolidone, or water when the water soluble binder is used, but is not limited thereto.

The positive electrode includes a current collector and a positive active material layer disposed on the current collector. The positive active material may include a compound that reversibly intercalates and deintercalates lithium (a lithiated intercalation compound). Specifically, a compound represented by one of the following formulas may be used: LiₐA_{1-b}X_{b}D₂ (0.90≦a≦1.8, 0≦b≦0.5); LiₐA_{1-b}X_{b}O_{2-c}D_{c} (0.90≦a≦1.8, 0≦b≦0.5, 0≦c≦0.05); LiₐE_{1-b}X_{b}O₂, D_{c} (0.90≦a≦1.8, 0≦b≦0.5, 0≦c≦0.05); LiₐE_{2-b}X_{b}O_{4-c}D_{c} (0.90≦a≦1.8, 0≦b≦0.5, 0≦c≦0.05); LiₐNi_{1-b-c}Co_{b}X_{c}D_{α} (0.90≦a≦1.8, 0≦b≦0.5, 0≦C≦0.5, 0<α≦2); LiₐNi_{1-b-c}Co_{b}X_{c}O₂-αT_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α≦2); LiₐNi_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦≦b≦0.1); LiₐCoG_{b}O₂ (0.90≦a≦1.8, 0.001≦b≦0.1); LiₐMn_{1-b}G_{b}O₂ (0.90≦a≦1.8, 0.001≦b≦0.1); LiₐMn₂G_{b}O₄ (0.90≦a≦1.8, 0.001≦b≦0.1); LiₐMn_{1-g}G_{g}PO₄ (0.90≦a≦1.8, 0≦g≦0.5); QO₂; QS₂; LiQS₂; V₂O₅; LiV₂O₅; LiZO₂; LiNiVO₄; Li_{(3-f)}J₂PO₄₃ (0≦f≦2); Li_{(3-f)}Fe₂PO₄₃ (0≦f≦2); and LiₐFePO₄ (0.90≦a≦1.8)

In the above formulae, A is selected from nickel (Ni), cobalt (Co), manganese (Mn), and a combination thereof; X is selected from Al, Ni, Co, Mn, Cr, Fe, Mg, Sr, V, a rare earth element, and a combination thereof; D is selected from oxygen (O), fluorine (F), S, P, and a combination thereof; E is selected from Co, Mn, and a combination thereof; T is selected from F, S, P, and a combination thereof; G is selected from Al, Cr, Mn, Fe, Mg, lanthanum (La), cerium (Ce), Sr, V, and a combination thereof; Q is selected from Ti, Mo, Mn, and a combination thereof; Z is selected from Cr, V, Fe, scandium (Sc), Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from an oxide of a coating element, a hydroxide of the coating element, an oxyhydroxide of the coating element, an oxycarbonate of the coating element, and a hydroxyl carbonate of the coating element. The compound for the coating layer may be amorphous or crystalline.

The coating element included in the coating layer may include Mg, Al, Co, K, Na, Ca, Si, Ti, V, Sn, Ge, Ga, B, As, Zr, or a mixture thereof. The coating layer may be disposed using a method having no adverse influence on properties of a positive active material by using these elements in the compound. For example, the method may include any coating method such as spray coating, dipping, or the like, but is not illustrated in more detail since it should be apparent to those who work in the related field.

In the positive active material layer, the mixture of a positive active material and an activated carbon coated with a fibrous carbon material may be in an amount ranging from about 90 wt % to about 98 wt % based on the entire weight of the positive active material layer. The positive active material layer also includes a binder and a conductive material. The binder and the conductive material may be included in an amount of about 1 wt % to about 5 wt % based on the total weight of the positive active material layer, respectively.

The binder improves binding properties of the positive active material particles to each other and to a current collector. Examples of the binder include polyvinyl alcohol, carboxylmethyl cellulose, hydroxypropyl cellulose, diacetyl cellulose, polyvinyl chloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material provides an electrode with electrical conductivity. Any electrically conductive material may be used as a conductive material unless it causes a chemical change. Examples of the conductive material include a carbon-based material such as natural graphite, artificial graphite, carbon black, acetylene black, ketjen black, a carbon fiber, or the like; a metal-based material such as a metal powder or metal fiber including copper, nickel, aluminum, silver, or the like; a conductive polymer such as polyphenylene derivative; and a mixture thereof.

The current collector may be Al, but is not limited thereto. The positive electrode may be fabricated by a method including mixing an active material, a conductive material, and a binder in a solvent to prepare an active material composition, and coating the active material composition on a current collector. The positive electrode manufacturing method is known, and thus is not described in more detail in the present specification. The solvent may be N-methylpyrrolidone, but is not limited thereto.

The rechargeable lithium battery may further include a separator between the negative electrode and the positive electrode, as needed. Examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The drawing is a schematic view of a representative structure of a rechargeable lithium battery according to one embodiment. As shown in the drawing, the rechargeable lithium battery 1 includes a battery case 5, a positive electrode 3, a negative electrode 2, and a separator 4 interposed between the positive electrode 3 and the negative electrode 2, an electrolyte solution impregnated therein, and a sealing member 6 sealing the battery case 5.

The following examples illustrate embodiments of the present invention in more detail. These examples, however, are not in any sense to be interpreted as limiting the scope of this disclosure.

### Example 1

Fluoroethylene carbonate and n-butyl acrylate were added to a mixture including 1M LiPF₆ dissolved in a mixed solvent of ethylene carbonate, ethylmethyl carbonate, and dimethyl carbonate (1:1:1 volume ratio) to prepare an electrolyte precursor.

A polyester polyol (as a polymerizable component, and obtained from the condensation of ethylene glycol, diethylene glycol, trimethylolpropane, and adipic acid, and represented by Chemical Formula 4, weight average molecular weight of about 60,000), and a 2,2-azo-bis-(2,4-dimethylvaleronitrile) polymerization initiator were added to the electrolyte precursor, to prepare an electrolyte.

An amount of fluoroethylene carbonate was about 3 wt % based on 100 wt % of the total amount of the electrolyte precursor, and an amount of the n-butyl acrylate was about 1.5 wt % based on 100 wt % of the total amount of the electrolyte precursor.

The amount of the polymerizable component was about 10 wt % based on the weight of the electrolyte, and the amount of the polymerization initiator was about 0.1 wt % based on the weight of the electrolyte.

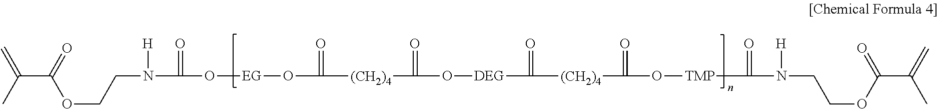

wherein, EG is a moiety of ethylene glycol; DEG is a moiety of diethylene glycol; and TMP is a moiety of trimethylolpropane.

The viscosity of the electrolyte was measured at a room temperature (25° C.) and the result was 8 centipoises (cPs).

A LiCoO₂ positive active material, a polyvinylidene fluoride binder (trade mark: KF7200®), and a denka black conductive material were mixed in an N-methylpyrrolidone solvent at a weight ratio of 98:1:1, to prepare a positive active material slurry. The positive active material slurry was coated on an Al current collector, dried and compressed to fabricate a positive electrode.

A graphite negative active material, a polyvinylidene fluoride binder (trade mark: KF7200®) and a denka black conductive material were mixed in an N-methyl pyrrolidone solvent at a weight ratio of 98:1:1, to prepare a negative active material slurry. The negative active material slurry was coated on a Cu current collector, dried and compressed, to fabricate a negative electrode.

A polyethylene film separator was inserted between the positive electrode and the negative electrode and the electrolyte was injected therein, thereby fabricating a rechargeable lithium cell with a capacity of 3600 mAh.

The rechargeable lithium cell was allowed to stand at 60° C. for 1 hour, to occur (conduct) a polymerization of the electrolyte within the rechargeable lithium cell. As a result, a rechargeable lithium cell including a gel polymer electrolyte was fabricated.

### Example 2

A rechargeable lithium cell with a gel polymer electrolyte was fabricated by the same procedure as in Example 1, except that the amount of n-butyl acrylate was changed to about 2 wt % based on 100 wt % of the total weight of the electrolyte.

### Example 3

A rechargeable lithium cell with a gel polymer electrolyte was fabricated by the same procedure as in Example 1, except that the amount of n-butyl acrylate was changed to about 1.25 wt % based on 100 wt % of the total weight of the electrolyte.

### Comparative Example 1

A rechargeable lithium cell with a gel polymer electrolyte was fabricated by the same procedure as in Example 1, except that n-butyl acrylate was not used.

### Comparative Example 2

A rechargeable lithium cell with a gel polymer electrolyte was fabricated by the same procedure as in Example 1, except that methyl acrylate was used in an amount of about 1.5 wt % based on 100 wt % of the total weight of the electrolyte, instead of n-butyl acrylate.

### Comparative Example 3

A rechargeable lithium cell with a gel polymer electrolyte was fabricated by the same procedure as in Example 1, except that ethyl acrylate was used in an amount of about 1.5 wt % based on 100 wt % of the total weight of the electrolyte, instead of n-butyl acrylate.

### Comparative Example 4

A rechargeable lithium cell with a gel polymer electrolyte was fabricated by the same procedure as in Example 1, except that allyl methacrylate was used in an amount of about 1.5 wt % based on 100 wt % of the total weight of the electrolyte, instead of n-butyl acrylate.

### Comparative Example 5

A rechargeable lithium cell with a gel polymer electrolyte was fabricated by the same procedure as in Example 1, except that amount of hexyl methacrylate was changed to about 1.5 wt % based on 100 wt % of the total weight of the electrolyte, instead of n-butyl acrylate.

### Comparative Example 6

A rechargeable lithium cell with a gel polymer electrolyte was fabricated by the same procedure as in Example 1, except that hydroxyethyl acrylate was used in an amount of about 1.5 wt % based on 100 wt % of the total weight of the electrolyte, instead of n-butyl acrylate.

### Comparative Example 7

n-butyl acrylate was added to an electrolyte precursor including 1 M LiPF₆ dissolved in a mixed solvent of ethylene carbonate, ethylmethyl carbonate, and dimethyl carbonate (1:1:1 volume ratio), to prepare a liquid electrolyte.

An amount of the n-butyl acrylate was about 1.5 wt % based on 100 wt % of the total amount of the electrolyte. The viscosity of the electrolyte was measured at a room temperature (25° C.) and the result was 2 cPs.

Determination of Numbers and Size for Uncharged Portions

The rechargeable lithium cells according to Examples 1 to 3 and Comparative Example 1 to 7 were charged and discharged at 1 C once, the rechargeable lithium cells were disassembled, and the numbers and sizes of the uncharged portions were measured. The results are shown in Table 1. In Table 1, EA refers to number.

TABLE 1

| | | Size of uncharged | Numbers for size for |
|---|---|---|---|
| | Additives, wt % | portions (mm) | the uncharged portions |
| Example 1 | n-butyl acrylate, 1.5 wt % | Diameter of 2 mm or less | 2EA |
| Example 2 | n-butyl acrylate, 2 wt % | Diameter of 2 mm or less | 2EA |
| Example 3 | n-butyl acrylate, 1.25 wt % | Diameter of 2 mm or less | 2EA |
| Comparative | No n-butyl acrylate | Diameter of 9 mm or | 7EA |
| Example 1 | | more | |
| Comparative | methyl acrylate, 1.5 wt % | Diameter of 5 mm or | 6EA |
| Example 2 | | more | |
| Comparative | ethyl acrylate, 1.5 wt % | Diameter of 5 mm or | 5EA |
| Example 3 | | more | |
| Comparative | allyl methacrylate, 1.5 wt % | Diameter of 5 mm or | 5EA |
| Example 4 | | more | |
| Comparative | hexyl methacrylate, 1.5 wt % | Diameter of 5 mm or | 5EA |
| Example 5 | | more | |
| Comparative | hydroxyethyl acrylate, 1.5 wt % | Diameter of 5 mm or | 6EA |
| Example 6 | | more | |
| Comparative | n-butyl acrylate, 1.5 wt % | Diameter of 2 mm or less | 4EA |
| Example 7 | | | |

As shown in Table 1, the sizes of the uncharged portions in the cells according to Examples 1 to 3 were smaller than those in the cells according to Comparative Examples 1 to 7. It can be expected from the results that the initial capacity and the inferior ratio for the OCV are reduced in Examples 1 to 3, compared to Comparative Examples 1 to 7.

Formation Capacity

The rechargeable lithium cells according to Examples 1 to 3 and Comparative Examples 1 to 7 were formation-charged at 1 C once, and the discharge capacity was measured. The results are shown in Table 2.

TABLE 2

| | | Capacity |
|---|---|---|
| | Additive, wt % | (mAh) |
| Example 1 | n-butyl acrylate, 1.5 wt % | 3700 |
| Example 2 | n-butyl acrylate, 2 wt % | 3720 |
| Example 3 | n-butyl acrylate, 1.25 wt % | 3690 |
| Comparative | No n-butyl acrylate | 3450 |
| Example 1 | | |
| Comparative | methyl acrylate, 1.5 wt % | 3640 |
| Example 2 | | |
| Comparative | ethyl acrylate, 1.5 wt % | 3760 |
| Example 3 | | |
| Comparative | allyl methacrylate, 1.5 wt % | 3630 |
| Example 4 | | |
| Comparative | hexyl methacrylate, 1.5 wt % | 3630 |
| Example 5 | | |
| Comparative | hydroxyethyl acrylate, | 3600 |
| Example 6 | 1.5 wt % | |
| Comparative | n-butyl acrylate, 1.5 wt % | 3730 |
| Example 7 | | |

As shown in Table 2, the cells according to Examples 1 to 3 exhibit higher capacity than those according to Comparative Example 1, 2, and 5 to 7.

Cycle-Life Characteristics

The rechargeable lithium cells according to Examples 1 to 3 and Comparative Examples 1 to 7 were charged and discharged at 1 C 200 times. When the discharge capacity at the first discharge cycle is referred to as 100%, the percentages, of the discharge capacity after 200 times were calculated. The results are shown in Table 3.

TABLE 3

| | | Cycle-life characteristic |
|---|---|---|
| | Additive, wt % | (%) |
| Example 1 | n-butyl acrylate, 1.5 wt % | 91 |
| Example 2 | n-butyl acrylate, 2 wt % | 84 |
| Example 3 | n-butyl acrylate, 1.25 wt % | 89 |
| Comparative | No n-butyl acrylate | 59 |
| Example 1 | | |
| Comparative | methyl acrylate, 1.5 wt % | 76 |
| Example 2 | | |
| Comparative | ethyl acrylate, 1.5 wt % | 80 |
| Example 3 | | |
| Comparative | allyl methacrylate, 1.5 wt % | 79 |
| Example 4 | | |
| Comparative | hexyl methacrylate, 1.5 wt % | 78 |
| Example 5 | | |
| Comparative | hydroxyethyl acrylate, 1.5 wt % | 79 |
| Example 6 | | |
| Comparative | n-butyl acrylate, 1.5 wt % | 62 |
| Example 7 | | |

As shown in Table 3, the cells according to Examples 1 to 3 exhibits better cycle-life characteristics, compared to the cells according to Comparative Examples 1 to 7. It can be clearly shown from the results in Table 2 and Table 3 that the cells according to Examples 1 to 3 exhibit better capacity and cycle-life characteristics, whereas, the cells according to Comparative Examples 1, 2 and 5 to 7 exhibit good capacity, but have deteriorated cycle-life characteristics.

### Example 4

A rechargeable lithium cell with a gel polymer electrolyte was fabricated by the same procedure as in Example 1, except that heptafluorobutyl acrylate was used in an amount of about 1.5 wt % based on 100 wt % of the total weight of the electrolyte, instead of n-butyl acrylate.

### Comparative Example 8

A rechargeable lithium cell with a gel polymer electrolyte was fabricated by the same procedure as in Example 4, except that methyl acrylate was used in an amount of about 1.5 wt % based on 100 wt % of the total weight of the electrolyte, instead of heptafluoroethyl acrylate.

### Comparative Example 9

A rechargeable lithium cell with a gel polymer electrolyte was fabricated by the same procedure as in Example 4, except that ethyl acrylate was used in an amount of about 1.5 wt % based on 100 wt % of the total weight of the electrolyte, instead of heptafluorobutyl acrylate.

### Comparative Example 10

A rechargeable lithium cell with a gel polymer electrolyte was fabricated by the same procedure as in Example 4, except that allyl methacrylate was used in an amount of about 1.5 wt % based on 100 wt % of the total weight of the electrolyte, instead of heptafluorobutyl acrylate.

The cells according to Example 4 and Comparative Examples 8 to 10 were formation charged at 1 C once, and the discharge capacity was measured. The results are shown in Table 4.

TABLE 4

| | Additive, wt % | Formation capacity (mAh) |
|---|---|---|
| Example 4 | heptafluoro butyl acrylate, | 3753 |
| | 1.5 wt % | |
| Comparative | methyl acrylate, 1.5 wt % | 3629 |
| Example 8 | | |
| Comparative | ethyl acrylate, 1.5 wt % | 3626 |
| Example 9 | | |
| Comparative | allyl methacrylate, 1.5 wt % | 3579 |
| Example 10 | | |

As shown in Table 4, the cell according to Example 4 exhibits higher capacity than the cells according to Comparative Examples 8 to 10.

### Example 5

A rechargeable lithium cell with a gel polymer electrolyte was fabricated by the same procedure as in Example 1, except that n-butyl acrylate was used at an amount of about 1.5 wt % based on 100 wt % of the total weight of the electrolyte precursor and the cell capacity was changed to 1200 mAh/g.

### Example 6

A rechargeable lithium cell with cell capacity of 1200 mAh/g and a gel polymer electrolyte was fabricated by the same procedure as in Example 5, except that hexyl acrylate was used at an amount of about 1.5 wt % based on 100 wt % of the total weight of the electrolyte, instead of n-butyl acrylate.

### Example 7

A rechargeable lithium cell with cell capacity of cell capacity of 1200 mAh/g and a gel polymer electrolyte was fabricated by the same procedure as in Example 5, except that isodecyl acrylate was used at an amount of about 1.5 wt % based on 100 wt % of the total weight of the electrolyte, instead of n-butyl acrylate.

### Comparative Example 11

A rechargeable lithium cell with cell capacity of 1200 mAh/g and a gel polymer electrolyte was fabricated by the same procedure as in Example 5, except that propyl acrylate was used at an amount of about 1.5 wt % based on 100 wt % of the total weight of the electrolyte, instead of n-butyl acrylate.

### Comparative Example 12

A rechargeable lithium cell with cell capacity of 1200 mAh/g and a gel polymer electrolyte was fabricated by the same procedure as in Example 5, except that behenyl acrylate was used at an amount of about 1.5 wt % based on 100 wt % of the total weight of the electrolyte, instead of n-butyl acrylate.

### Comparative Example 13

A rechargeable lithium cell with cell capacity of 1200 mAh/g and a gel polymer electrolyte was fabricated by the same procedure as in Example 5, except that n-butyl methacrylate was used at an amount of about 1.5 wt % based on 100 wt % of the total weight of the electrolyte, instead of n-butyl acrylate.

The rechargeable lithium cells according to Examples 5 to 7 and Comparative Example 11 to 13 were charged at 1 C once, and the discharge capacity was measured. The results are shown in Table 5, as capacity. Furthermore, the rechargeable lithium cells according to Examples 5 to 7 and Comparative Example 11 to 13 were charged and discharged at 1 C 100 times. When the discharge capacity at first discharge cycle refers to 100%, the percentages, of the discharge capacity after 100 times were calculated. The results are shown in Table 5.

TABLE 5

| | | Carbons in | | |
|---|---|---|---|---|
| | | alkyl group | | Cycle-life |
| | | of | Capacity | characteristic |
| | Additive | the additive | (mAh) | (%) |
| Comparative | propyl acrylate | 3 | 1132 | 57 |
| Example 11 | | | | |
| Example 5 | n-butyl acrylate | 4 | 1309 | 92 |
| Example 6 | hexyl acrylate | 6 | 1287 | 92 |
| Example 7 | isodecyl acrylate | 13 | 1237 | 91 |
| Comparative | behenyl acrylate | 22 | 1126 | 59 |
| Example 12 | | | | |
| Comparative | n-butyl | 4 | 1108 | 61 |
| Example 13 | methacrylate | | | |

As shown in Table 5, the rechargeable lithium cells according to Examples 5 to 7, using an alkyl acrylate with a C4 to C13 alkyl group, exhibited good capacity and cycle-life characteristics, whereas the rechargeable lithium cells according to Comparative Examples 11 and 12 using an alkyl acrylate with a C3 alkyl group or a C22 alkyl group exhibited lower capacity and extremely lower cycle-life characteristics, compared to those of the cells according to Examples 5 to 7.

Furthermore, the rechargeable lithium cell according to Comparative Example 13, using alkyl methacrylate even though the alkyl group has four carbons, rather than an alkyl acrylate, exhibited deteriorated capacity and cycle-life characteristics.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electrolyte for a rechargeable lithium battery comprising:
an alkyl acrylate additive comprising a C4 to C15 alkyl group;
fluoroethylene carbonate;
a polymerizable component;
a polymerization initiator;
a lithium salt; and
an organic solvent.

2. The electrolyte of claim 1, wherein the alkyl acrylate additive comprises a halogenated alkyl acrylate.

3. The electrolyte of claim 2, wherein 1 to 31 hydrogen atoms of the alkyl acrylate additive are substituted with a halogen.

4. The electrolyte of claim 1, wherein the alkyl acrylate additive comprises a material selected from the group consisting of n-butyl acrylate, hexyl acrylate, isodecyl acrylate, heptafluoro butyl acrylate, and combinations thereof.

5. The electrolyte of claim 1, wherein the alkyl acrylate additive is present in the electrolyte in an amount of about 1.25 wt % to about 2 wt % based on the total weight of the electrolyte.

6. The electrolyte of claim 1, wherein a weight ratio of the alkyl acrylate additive to the polymerizable component is in a range of 1:2 to 1:10.

7. The electrolyte of claim 1, wherein the electrolyte has a viscosity of 4 cps to 30 cps.

8. The electrolyte of claim 1, wherein the polymerizable component comprises a material selected from the group consisting of a multifunctional acrylate, poly(ethylene glycol)dimethacrylate, poly(ethylene glycol)diacrylate, poly(ethylene glycol)divinyl ether, ethylene glycol dimethacrylate, ethylene glycol diacrylate, ethylene glycol divinyl ether, hexanediol diacrylate, tripropylene glycol diacrylate, tetraethylene glycol monoacrylate, caprolactone acrylate, a polyester polyol, and combinations thereof.

9. The electrolyte of claim 1, wherein the polymerizable component comprises a material represented by Chemical Formula 1: 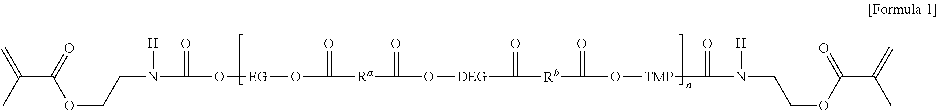
wherein, R^{a} and R^{b} are the same or different, and are substituted or unsubstituted C1 to C6 alkylene;
EG is a moiety of ethylene glycol;
DEG is a moiety of diethylene glycol; and
TMP is a moiety of trimethylolpropane.

10. The electrolyte of claim 1, wherein the fluoroethylene carbonate is included in a range of about 1 wt % to about 20 wt % based on the total weight of the electrolyte.

11. A rechargeable lithium battery comprising:
a positive electrode comprising a positive active material;
a negative electrode comprising a negative active material; and
an electrolyte comprising the reaction product of an electrolyte mixture comprising:
an alkyl acrylate additive comprising a C4 to C15 alkyl group;
fluoroethylene carbonate;
a polymerizable component;
a polymerization initiator;
a lithium salt; and
an organic solvent.

12. The rechargeable lithium battery of claim 11, wherein the alkyl acrylate additive comprises a halogenated alkyl acrylate.

13. The rechargeable lithium battery of claim 12, wherein 1 to 31 hydrogen atoms of the alkyl acrylate additive are substituted with a halogen.

14. The rechargeable lithium battery of claim 11, wherein the alkyl acrylate additive comprises a material selected from the group consisting of n-butyl acrylate, hexyl acrylate, isodecyl acrylate, heptafluoro butyl acrylate, and combinations thereof.

15. The rechargeable lithium battery of claim 11, wherein the alkyl acrylate additive is present in the electrolyte mixture in an amount of about 1.25 wt % to about 2 wt % based on the total weight of the electrolyte mixture.

16. The rechargeable lithium battery of claim 11, wherein a weight ratio of the alkyl acrylate additive to the polymerizable component is in a range of 1:2 to 1:10.

17. The rechargeable lithium battery of claim 11, wherein the fluoroethylene carbonate is included in a range of about 1 wt % to about 20 wt % based on the total weight of the electrolyte mixture.

18. The rechargeable lithium battery of claim 11, wherein the electrolyte is a gel electrolyte.

19. The rechargeable lithium battery of claim 11, wherein the polymerizable component comprises a material selected from the group consisting of a multifunctional acrylate, poly(ethylene glycol)dimethacrylate, poly(ethylene glycol)diacrylate, poly(ethylene glycol)divinyl ether, ethylene glycol dimethacrylate, ethylene glycol diacrylate, ethylene glycol divinyl ether, hexanediol diacrylate, tripropylene glycol diacrylate, tetraethylene glycol monoacrylate, caprolactone acrylate, a polyester polyol, and combinations thereof.

20. The rechargeable lithium battery of claim 11, wherein the polymerizable component comprises a material represented by Chemical Formula 1: 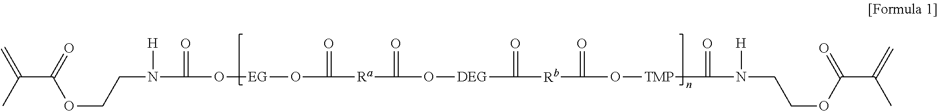
wherein, R^{a} and R^{b} are the same or different, and are substituted or unsubstituted C1 to C6 alkylene;
EG is a moiety of ethylene glycol;
DEG is a moiety of diethylene glycol; and
TMP is a moiety of trimethylolpropane.
